(19) United States
(12) Patent Application Publication
(10) Pub. No.: US 2019/0382112 A1
(43) Pub. Date: Dec. 19, 2019

(54) BATTERY POD UNMANNED AERIAL VEHICLE

(71) Applicant: United Technologies Corporation, Farmington, CT (US)

(72) Inventor: Marc J. Muldoon, Marlborough, CT (US)

(21) Appl. No.: 16/012,027

(22) Filed: Jun. 19, 2018

(51) Int. Cl. B64C 39/02; B64C 37/02; B64D 41/00; B64D 27/24; B64D 27/12

(52) U.S. Cl. CPC B64C 39/024; B64C 37/02; B64D 41/00; B64D 27/24; B64C 2201/206; B64C 2201/126; B64C 2201/141; B64C 2201/042; B64C 2201/048; B64D 27/12

(57) ABSTRACT

A method of operating an aircraft according to an exemplary embodiment of this disclosure includes, among other possible things, communicating power from a storage device within an unmoved aerial vehicle (UAV) to an aircraft; controlling a propulsive device within the UAV with a control system of the aircraft to provide propulsive thrust to the aircraft; and detaching the UAV including the storage device and the propulsion device from the aircraft responsive to the energy within the storage device being below a predefined threshold.

### BACKGROUND

Aircraft are increasingly utilizing electrically powered devices and motors that increase demands on power storage and generating devices. Increased amounts of electric power can be obtained by increasing the size of power generating devices. However, the peak demands for power generation are often at idle or takeoff conditions. Accordingly, a power generating device sized to meet peak demand requirements may be oversized for most operating conditions including for example aircraft cruise conditions. Additionally, while battery power can be utilized to supplement operation during peak conditions, batteries maintain a fixed weight regardless of the amount of power remaining. Aircraft and engine manufactures continue to seek improvements to aircraft operation to improve performance and propulsive efficiencies.

Aircraft and engine manufactures continue to seek improvements to aircraft operation to improve performance and propulsion efficiencies.

### SUMMARY

A method of operating an aircraft according to an exemplary embodiment of this disclosure includes among other possible things, communicating power from a storage device within an unmoved aerial vehicle (UAV) to an aircraft; controlling a propulsive device within the UAV with a control system of the aircraft to provide propulsive thrust to the aircraft; and detaching the UAV including the storage device and the propulsion device from the aircraft responsive to the energy within the storage device being below a predefined threshold.

In a further embodiment of the foregoing method of operating an aircraft, the storage device comprises a battery and communicating power comprises communicating electric energy to at least one system of the aircraft from the battery within the UAV.

In a further embodiment of any of the foregoing methods of operating an aircraft, controlling the propulsive device provides a propulsive thrust during takeoff operation of the aircraft.

In a further embodiment of any of the foregoing methods of operating an aircraft, controlling the propulsive device to provide a propulsive thrust until the storage device is below the predefined threshold is included.

In a further embodiment of any of the foregoing methods of operating an aircraft, guiding the UAV to away from the aircraft to a predefined location for retrieval is included.

In a further embodiment of any of the foregoing methods of operating an aircraft, the UAV includes control surfaces and a controller to autonomously guide the UAV away from the aircraft and to the predefined location.

In a further embodiment of any of the foregoing methods of operating an aircraft, guiding the UAV away from the aircraft in a non-powered condition is included.

In a further embodiment of any of the foregoing methods of operating an aircraft, the propulsion device comprises an electric motor driving propeller blades. The electric motor draws power from the storage device.

In a further embodiment of any of the foregoing methods of operating an aircraft, moving the propeller blades to a retracted position when not providing propulsive thrust is included.

In a further embodiment of any of the foregoing methods of operating an aircraft, the propulsion device comprises a gas turbine engine and the UAV includes fuel storage for powering the gas turbine engine.

An unmanned aerial vehicle (UAV) for supplying power to another aircraft, the UAV, according to an exemplary embodiment of this disclosure includes, among other things, a power supply communicating power to an aircraft; a motor generating a propulsive thrust; at least one control surface for controlling a direction of the vehicle independent of the main aircraft; and a controller governing operation of the motor and the control surface, wherein the controller is configured to operate the motor responsive to commands from the aircraft to provide propulsive thrust to the aircraft.

In a further embodiment of the foregoing UAV for supplying power to another aircraft the power supply provides electric power to at least one system of the aircraft.

In another embodiment of any of the foregoing UAV for supplying power to another aircraft, a mount enabling separation of the UAV from the aircraft such that the UAV may be separated from the aircraft in response to the power supply being depleted below a predefined threshold is included.

In another embodiment of any of the foregoing UAV for supplying power to another aircraft, the motor of the UAV provides propulsive thrust to the aircraft during takeoff operations.

In another embodiment of any of the foregoing UAV for supplying power to another aircraft, the motor of the UAV provides propulsive thrust until the power supply is depleted below a predefined threshold.

In another embodiment of any of the foregoing UAV for supplying power to another aircraft, the motor comprises an electric motor driving a propeller.

In another embodiment of any of the foregoing UAV for supplying power to another aircraft, the propellers are movable to a stowed position.

In another embodiment of any of the foregoing UAV for supplying power to another aircraft, hinges are attached to the propellers to enable movement from the stowed position to a deployed position. An end stop limiting outward radial movement about the hinges in the deployed position is included.

In another embodiment of any of the foregoing UAV for supplying power to another aircraft, the motor comprises a gas turbine engine.

Although the different examples have the specific components shown in the illustrations, embodiments of this invention are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an aircraft including an unmanned aerial vehicle auxiliary power supply.

FIG. 2 is a schematic view of the aircraft and a detached unmanned aerial vehicle auxiliary power supply.

FIG. 3 is a schematic view of an example unmanned aerial vehicle auxiliary power supply.

FIG. 4 is a schematic view of the example unmanned aerial vehicle auxiliary power supply with propeller blades in a stowed position.

FIG. 5 is a schematic view of another example unmanned aerial vehicle auxiliary power supply.

### DETAILED DESCRIPTION

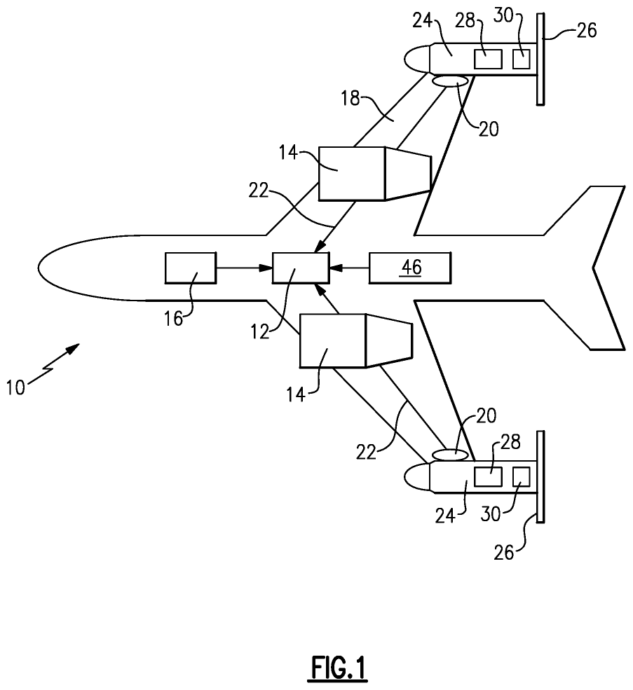

FIG. 1 schematically illustrates an aircraft 10 including an aircraft system 12 that draws power from a power source located within an unmanned aerial vehicle (UAV) auxiliary power supply 24. The aircraft 10 includes engines 14 that provide propulsive thrust and a controller 16. Increasing demands for electric power for various aircraft systems schematically shown at 12 is accommodated by a power storage device provided in the UAV 24. In this example, the power storage device is a battery 28 that communicates electric power to the aircraft 10.

A battery maintains a constant volume and weight once discharged and no longer capable of providing electric energy. Unlike fuel that is burned to produce power and therefore once used no longer contributes to the load on the aircraft, the battery is a constant load on the aircraft regardless of the level of energy. The example UAV 24 is detachable from the aircraft 10 once the battery 28 is no longer providing energy to the aircraft 10. In this example embodiment, two (2) UAVs 24 are mounted to the aircraft structure 18. In this example, the UAVs 24 are mounted on the wings of the aircraft 10 outboard of the aircraft engines 14. In this disclosed example, the aircraft engines 14 are gas turbine engines. However, the example engines 14 may be of any other type of engine.

The UAVs 24 include the power storage device that in this example is a battery 28. It should be appreciated that the battery 28 may be a single battery or a group of batteries or other power cell configuration that produces an electric output. The battery 28 is coupled through electrical conduits 22 to the aircraft system 12. The aircraft system 12 may be any system that utilizes electric energy including control, environmental control and/or propulsion systems. Moreover, the UAVs 24 may provide electric power that is used prior to power from any additional on board power storage systems schematically indicated at 46.

The disclosed UAVs 24 include a motor 30 that drives propeller blades 26. The motor 30 and propeller blades 26 are controllable by the aircraft controller 16 while coupled to the aircraft 10. The aircraft controller 16 controls operation of the UAV motor 30 to provide additional propulsive thrust for high thrust demand aircraft operation such as during a takeoff operation. The motor 30 of the UAV 24 may also be utilized to assist in aircraft operation to reduce the load on the aircraft engines 14 to conserve onboard energy stores such as fuel. Moreover, the power provided by the UAV battery 28 can be utilized in other situations where use of on board aircraft energy stores is the least efficient such as for example while idling or taxing on the ground.

The example motor 30 is driven by power supplied by the battery 28 of each corresponding UAV 24. Accordingly, the battery 28 provides electric energy to the aircraft 10 and also to power the motor 30 to provide additional propulsive thrust.

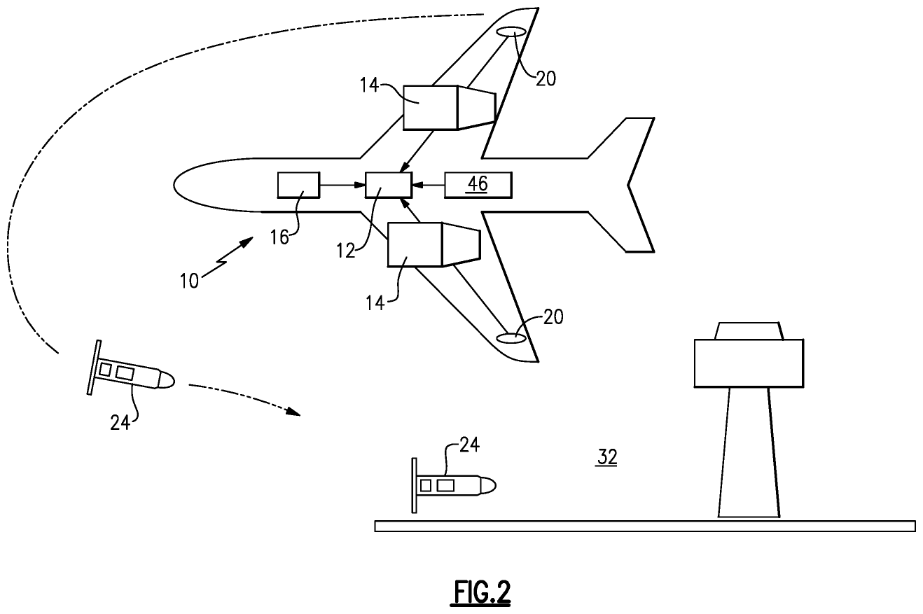

Referring to FIG. 2 with continued reference to FIG. 1, once the battery 28 has been depleted of charge below a predefined threshold value, the UAV 24 can be detached from the aircraft 10 to eliminate the load on the aircraft. Once the battery 28 has been depleted, it no longer provides a benefit to aircraft operation and is detached from the corresponding mount 20. Detachment of the UAV 24 can be facilitated at the instruction of the aircraft controller 16 in response to detection of a charge of the battery 28 being below a predefined threshold value. The predefined threshold value can be that value where a determined benefit provided by the battery 28 is less than the load placed on aircraft operation. In another example embodiment, the UAV 24 may be detached after a predefined time and/or range from a predefined retrieval location. Moreover, detachment of the UAVs 24 may also be manually performed by operators of the aircraft to accommodate unique operational requirements that do not meet other predefined parameters.

Once the UAVs 24 are detached from the aircraft 10, they will move away from the aircraft 10 to reduce the load on the aircraft 10. The UAVs 24 may then guide themselves back to a retrieval location schematically shown at 32. At the retrieval location, the UAVs 24 may be recharged for remounting to an aircraft 10.

The UAVs 24 may proceed away from the aircraft 10 in a powered condition using power from the battery 28 to provide power to drive the motor 30. If the motor 30 is driven, the charge level of the battery 28 that triggers detachment of the UAV 24 from the aircraft 10 will account for the power required to propel the UAV 24 back to the retrieval location 32.

In another example embodiment, the UAV 24 may glide to the retrieval location 32 in an unpowered condition. Gliding the UAV 24 back to the retrieval location enables a longer duration of power supplied to the aircraft 10.

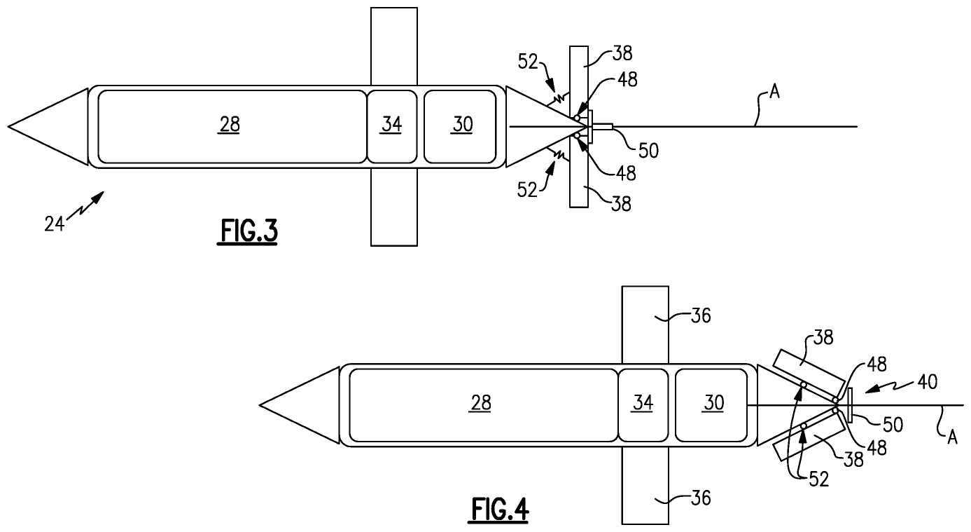

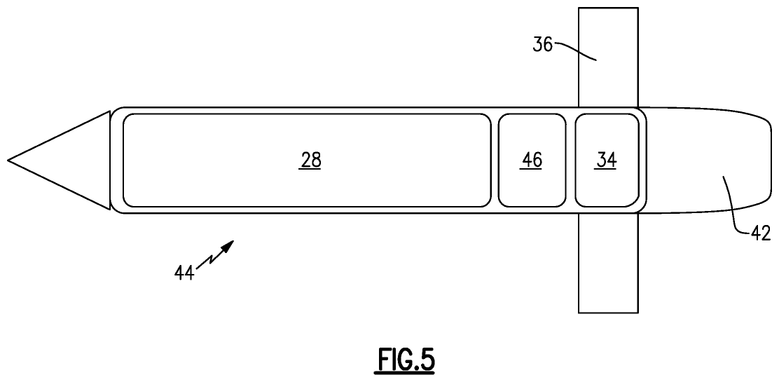

Referring to FIGS. 3 and 4 with continued reference to FIGS. 1 and 2, the example UAV 24 can include collapsible propeller blades 38. In this disclosed example, the propeller blades 38 are movable to a stowed position, schematically indicated at 40 in FIG. 4, to reduce drag. The example UAV 24 includes control surfaces 36 and an onboard controller 30 that can enable autonomous operation. The UAV 24 may also be controlled remotely by an operator that controls the UAV 24 through a wireless communication link once detached from the aircraft 10.

The blades 38 are connected by way of a hinges 48 to enable movement from the stowed position to the deployed position as shown in FIG. 3. The blades 38 rotate outwardly about the hinges 48 in response to centrifugal and propulsive forces on the blades 38. An end stop 50 is provided that limits outward rotation of the blades 38 about the hinges 48 but does not restrict rotation about a propeller axis A. Propulsive forces on the blades 38 in the forward direction maintain deployment until power is stopped and rotation of the blades 38 is stopped. A biasing member 52 is schematically shown and provides the inward force needed to pulls the blades 38 radially inward about the corresponding hinges 48 back to the stowed position.

Referring to FIG. 5 another example UAV 44 is shown that includes a gas turbine engine 42 to provide propulsive thrust. The turbine engine 42 is powered by an onboard fuel supply 46.

Accordingly, the disclosed UAV provides auxiliary battery power to an aircraft to meet increased demands and reduce loads on primary systems during pre-flight, ground idle, takeoff, climb and other high or inefficient power demand conditions while also providing additional propulsive thrust during takeoff that may than be detached from the aircraft and recovered for recharging and reuse.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A method of operating an aircraft comprising:
communicating power from a storage device within an unmoved aerial vehicle (UAV) to an aircraft;
controlling a propulsive device within the UAV with a control system of the aircraft to provide propulsive thrust to the aircraft; and
detaching the UAV including the storage device and the propulsion device from the aircraft responsive to the energy within the storage device being below a predefined threshold.

2. The method as recited in claim 1, wherein the storage device comprises a battery and communicating power comprises communicating electric energy to at least one system of the aircraft from the battery within the UAV.

3. The method as recited in claim 2, including controlling the propulsive device to provide a propulsive thrust during takeoff operation of the aircraft.

4. The method as recited in claim 2, including controlling the propulsive device to provide a propulsive thrust until the storage device is below the predefined threshold.

5. The method as recited in claim 1, including guiding the UAV to away from the aircraft to a predefined location for retrieval.

6. The method as recited in claim 5, wherein the UAV includes control surfaces and a controller to autonomously guide the UAV away from the aircraft and to the predefined location.

7. The method as recited in claim 6, including guiding the UAV away from the aircraft in a non-powered condition.

8. The method as recited in claim 1, wherein the propulsion device comprises an electric motor driving propeller blades, wherein the electric motor draws power from the storage device.

9. The method as recited in claim 8, including moving the propeller blades to a retracted position when not providing propulsive thrust.

10. The method as recited in claim 1, wherein the propulsion device comprises a gas turbine engine and the UAV includes fuel storage for powering the gas turbine engine.

11. An unmanned aerial vehicle (UAV) for supplying power to another aircraft, the UAV comprising:
a power supply communicating power to an aircraft;
a motor generating a propulsive thrust;
at least one control surface for controlling a direction of the vehicle independent of the main aircraft; and
a controller governing operation of the motor and the control surface, wherein the controller is configured to operate the motor responsive to commands from the aircraft to provide propulsive thrust to the aircraft.

12. The UAV as recited in claim 11, wherein the power supply provides electric power to at least one system of the aircraft.

13. The UAV as recited in claim 12, including a mount enabling separation of the UAV from the aircraft such that the UAV may be separated from the aircraft in response to the power supply being depleted below a predefined threshold.

14. The UAV as recited in claim 11, wherein the motor of the UAV provides propulsive thrust to the aircraft during takeoff operations.

15. The UAV as recited in claim 11, wherein the motor of the UAV provides propulsive thrust until the power supply is depleted below a predefined threshold.

16. The UAV as recited in claim 11, wherein the motor comprises an electric motor driving a propeller.

17. The UAV as recited in claim 16, wherein the propellers are movable to a stowed position.

18. The UAV as recited in claim 17, including hinges attached to the propellers to enable movement from the stowed position a deployed position and an end stop limiting outward radial movement about the hinges in the deployed position.

19. The UAV as recited in claim 11, wherein the motor comprises a gas turbine engine.
